(19) United States
(12) Patent Application Publication
(10) Pub. No.: US 2009/0303739 A1
(43) Pub. Date: Dec. 10, 2009

(54) Adjustable underhood light

(76) Inventor: Thomas Garcia, Manor, TX (US)

Correspondence Address: JAMES MINERVE, 12118 WALNUT PARK CROSSING, APT 635, AUSTIN, TX, 78753, US

(21) Appl. No.: 12/157,415

(22) Filed: Jun. 10, 2008

(51) Int. Cl. B60Q 1/00; F21V 19/02

(52) U.S. Cl. 362/496; 362/220

(57) ABSTRACT

An adjustable light, comprising, a power track, two clips, a battery cable, a repositionable semi-rigid corrugated tube and a plurality of line voltage pendant lights. The two clips slidably insert into track upper channel, wherein the clips clamp the track to the lateral edges of the underside of any size automobile hood. The battery cables supply low voltage power to the track. The tubes connect the lights to the track lower channel. An auto mechanic working under an auto hood can reposition the lights by bending the tubes, which remain in bent position until repositioned.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

1. Field of the Invention

This invention relates generally to utility lights and, more specifically, to an adjustable utility light suitable for being suspended from the hood of a vehicle or the like.

2. Description of Related Art

While working on automobiles, automobile mechanics frequently use utility lights to illuminate remote or recessed areas of the automobile. Such conditions are particularly aggravated when working on automobile engines, which are covered by a hood blocking room or ambient light. It would be especially useful to introduce an adjustable utility light suitable to illuminate the remote and recessed compartments of an automobile engine.

Existing products include a fluorescent light fixture connected to a bracket featuring spring-loaded hooks that allow the bracket to be temporarily installed under the vehicle hood or inserted in other places on the vehicle. See, for example, U.S. Pat. No. 4,197,573 for a droplight construction. The light disclosed in the aforementioned patent includes a hollow frame and retractable and rotatable hooks at each end of the frame, at least one of the hooks being connected through a spring to a center post of the frame. Incandescent lamp sockets are provided at opposing ends of the frame. One problem with the construction is the requirement that the springs within the frame be connected to a center post in the frame, which is not very accessible. The resulting construction is, therefore, more complex to assemble and more costly to manufacture than necessary.

A portable work light is disclosed in U.S. Pat. No. 5,836,679, which has a fluorescent-type lamp and a pair of fasteners attached to the tube. A cord is formed as an adjustable loop. Fasteners are provided for suspending the work light to the cord. However, such work light requires an external adjustable loop that needs to be placed around a member, such as the hood of an automobile. The entire cord assembly, therefore, is exposed, making the cord more susceptible to damage from sharp objects, including the edges of the hood itself. The elongate cord can also engage or snag other items in a workshop or garage, making the item cumbersome to use.

A magnetically mounted work light is disclosed in U.S. Pat. No. 5,457,614 that includes a pair of magnetic base members for supporting a light on a magnetic surface. Arcuate arms extend from each of the base members and a fluorescent light is supported at an end of the arms spaced from the base members. The arms may be pivoted relative to the base members in order to position the light at a desired location relative to a work area. However, such magnetically mounted light may not be as stably secured, to the extent desired, to a surface, such as a hood of an automobile. Jarring the light with a tool or other device might cause the light to be knocked off the magnetic supporting surface. Also, being made of a welded construction with arcuate arms, the work light is bulky and difficult to store when not in use. Similar remarks can be made of the fluorescent utility light disclosed in U.S. Pat. No. 5,436,815.

An adjustable florescent light is disclosed in U.S. Pat. No. 6,799,863 that includes gripping members, which only slightly extend the axial length of the light and do not securely attach to the underside of a hood. This invention, as well as the others aforementioned, casts a blanket of overhead light illuminating the top surface of the under hood compartments of an automobile. However, this neither any other prior art utility light amply illuminates the remote and recessed compartments under vehicle hoods.

### BRIEF SUMMARY OF THE INVENTION

Accordingly, it is an object of the invention to provide an adjustable utility light that does not have the disadvantages inherent in the utility lights that have been known.

It is another object of the present invention to provide an adjustable utility light that is simple in construction and economical to manufacture.

It is still another object of the invention to provide an adjustable utility light that is convenient to use.

It is yet another object of the invention to provide a utility light that can be well secured to the underside of an automobile with minimum risk that the light will be inadvertently jarred loose.

It is still a further object of the invention to provide an adjustable utility light as in the previous objects that provides concentrated illumination to remote and recessed areas of automobile-underhood compartments.

It is yet a further object of the invention to provide an adjustable utility light as in the previous objects that is particularly suitable for providing illumination during maintenance and repair of automobiles, light trucks and similar vehicles.

In order to achieve the above objects, as well as others that will become apparent hereinafter, an adjustable light for suspension from an object having a nominal width and lateral edges comprises an elongated rigid frame having opposing ends, having two clips each being connected proximal to a separate opposing frame end, a frame axial axis, and opposing upper and lower surfaces. The frame opposing ends are clamped to the underside of a typical automobile hood by the clips when the hood is raised in a fixed position. The frame is electrically connected to a power source.

The adjustable light also comprises a plurality of pendant light fixtures, each comprising a light fixture head; and a repositionable semi-rigid elongated extension. One end of each extension is detachably and electrically connected to the frame lower surface and the other extension end is detachably and electrically connected to one of the light fixture heads. Each extension is repositionable so as an auto mechanic working under an automobile hood could reposition each pendant light fixture by bending one of the extensions to variously illuminate remote and recessed areas under the hood; wherein once bent into position, the extension remains rigid unless and until the user repositions the extension.

Other objects and advantages of the present invention will be readily apparent upon a reading of the following brief descriptions of the drawing figures, detailed descriptions of preferred embodiments of the invention, the appended claims and drawings.

### BRIEF DESCRIPTION OF THE SEVERAL VIEWS OF THE DRAWINGS

The above mentioned and other objects and features of this invention and the manner of attaining them will become apparent, and the invention itself will be best understood by reference to the appended drawings. In the course of the following detailed description, reference will be made to the appended drawings in which:

FIG. 1. Is a side view of a preferred embodiment of the Adjustable Under hood Light.

FIG. 2A. Is a component isometric of a preferred embodiment of the Frame.

FIG. 2B. Is a component side view of a preferred embodiment of the Frame.

### DESCRIPTION

### Definitions

Buss Bar. A copper bar, strap, or other similar conductor that is not insulated, usually carries an electrical current, and connects electrical fixtures to electrical circuits.
Line Voltage Pendant Light Fixture. A low voltage track light fixture that does not contain a transformer to reduce the voltage from a 120 volts to 12 volts.
Power Track. A long, slender rigid frame made of extruded aluminum (other metal, or thermoplastic) channels, lined with plastic sleeves housing bus bars for providing power from remote power sources. An example is a residential-track-lighting track.
Clip. A clamp with a handle portion pivotally and operatively connected to a set of jaws. The jaws are biased together. The clip clamps to objects by squeezing the handle opening the jaws, placing the object in between the jaws, and releasing the handle.
Electrically Connected. Transferring an electrical current from an electrical power source to an electrical fixture in accordance with the National Electrical Code.
Power Source. An electrical power source, such as a 120 volt, duplex electrical receptacle.
Lamp. A low voltage (less than 110/120 volts) incandescent or halogen light bulb.
Transformer. An electrical transformer for reducing the current of a 110/120 volt electrical receptacle to a level suitable for low voltage line voltage pendant light fixtures.
Power Source Pack. A compacted electrical transformer for reducing the current of a 110/120 volt electrical receptacle to a level suitable for low voltage line voltage pendant light fixtures, that attaches to one end of a Power Track.

### DETAILED DESCRIPTION OF THE INVENTION

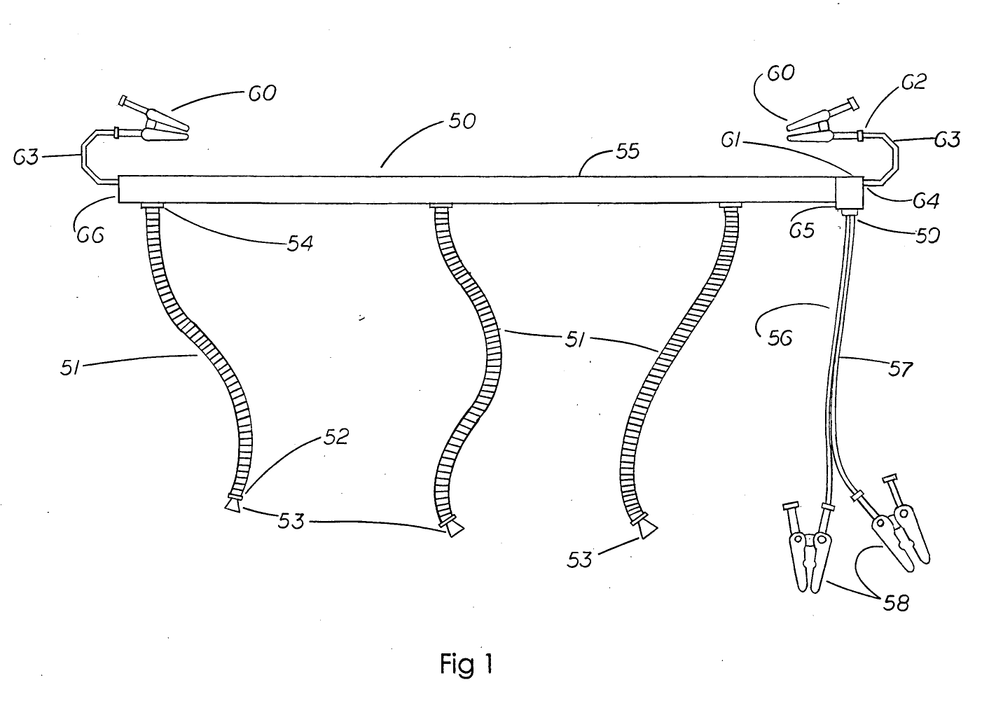

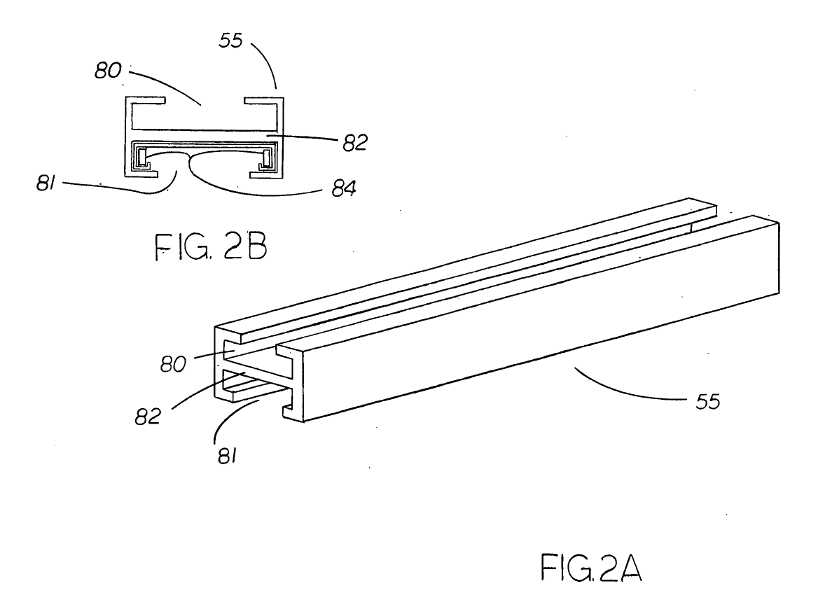

In the following description, like reference characters designate like or corresponding parts throughout the several views. Referring now to the drawings in detail, reference is made to FIGS. 1, 2A and 2B. A preferred embodiment of the present invention comprises an adjustable underhood light 50 comprising: an elongated power track 55, having opposing ends 61 and 66, having upper 80 and lower 81 opposing internal channels, sharing the same channel base 82, extending the length of the track 55, defining the track axial axis 83. Electrically conductive bus bars 84 extending the length of the track 55 are inserted into the lower channel 81.

Two detachable clips 60 each comprising planar portions 64 sized to snug fit inside the upper channel 80, each being slidably inserted along the track axial axis 83 into the upper channel 80 proximal to separate said track ends 61 and 66. Each planar clip portion 64 is capable of sliding beyond the length of the track 55 effectively extending the length of the track 55, whereby the track length is retractable. The length of the track 55 is sized so as each clip 60 is capable of being fastened to the opposing lateral edges of the underside of a typical automobile hood (not shown). Being that the track length is retractable, as stated, the track 55 is capable of being fastened to automobile hoods of any size width.

Battery cables 56 comprising electrical wiring 57 and two clamps 58 are electrically connected to the bus bars 84 at one track end 61. The length of the cables 56 being sized such that the clamps 58 can be fastened to the leads of an automobile's battery while the hood is up and the clips 60 are fastened to said lateral hood edges (not shown).

This preferred embodiment further comprises a plurality of line voltage pendant light fixtures 86, comprising a semi-rigid corrugated tube 51; a fixture head 53 with a lamp (not shown) at one tube end 52; an electrical base 54 at the other tube end 70; electrical wiring (not shown) inside the tube 51 extending the length of the tube 51 connected to the electrical base 54 and fixture head 53. Each electrical base 54 is inserted inside the lower channel 81 electrically contacting the electrically conductive bus bars 84; whereby power is capable of being transferred from the car battery, through the cables 56, through the bus bars 84, through the electrical wring, to the fixture head 53 lighting the lamp (not shown). The corrugated tubing 51 is repositionable so as a mechanic working under the hood could reposition each line voltage pendant light fixture 86 by bending the tubing 51 to variously illuminate remote and recessed areas under the hood, including engine components; wherein once bent into position, the tubing 51 remains rigid unless and until the user repositions the tubing 51.

This preferred embodiment manifests a variety of advantages over the prior art. First, the preferred embodiment uses clips 60 that tightly clasp to the lateral edges of an automobile hood making it very easy to secure the apparatus to the underside of a hood, making inadvertently jarring loose the clips very unlikely. All of the prior art utility lights did not securely fasten to the hood. Second, being that the clips 60 slidably attach to the track 55, having planar portions 64 that fit into the track upper channels 80 sliding along the track axial axis 83, the apparatus can be adjusted to clamp to the lateral sides of any size automobile hood by simply sliding the clips 60 along the upper channels 80. The ideal length of the track 55 is sized to match the width of an average size SUV. However, the track length is retractable by virtue of the slidable clips, enabling the power track 50 to be fastened to any size hood.

Third, unlike the prior art, which only provides overhead lighting from florescent lights fixed in one position or bulky fixed incandescent lights capable of rotating only, or flash lights, which must be held by the mechanic; the present invention enables a mechanic to cast concentrated light (just like a flashlight) on any recessed area under the hood. To reposition the light, the mechanic only has to bend the extension 51 and move the fixture head to any position under the hood. Because the extension 51 is semi-rigid, the bent shape of the extension will not unfurl due to the weight of the fixture head. Typical prior art track fixture heads contain heavy transformers. The increased weight of the fixture would unfurl a bent extension 15 making repositioning of the fixture head 53 difficult. The present invention overcomes this problem by using line voltage pendant light fixture heads 53, which can be made much smaller and lighter in weight. Line voltage pendant light fixtures generate more heat than typical track lights. This disadvantage can be overcome by insulating the extensions 51. To reach very remote recessed areas under an automobile hood, it is best to have at least one extension 53 long enough to reach the underside of the engine while the apparatus is attached to the hood with the hood is raised.

Still referring to FIGS. 1, 2A and 2B, in another preferred embodiment, the track 55 is arcuate, slightly bowed toward the hood underside. The arcuate shape conserves space because the width of the typical automobile hood is slightly convex. If the track is obstructing the mechanic from reaching a certain area under a hood, or to gain access to a certain area under a hood, an auto mechanic can simply unclamp the clips, by depressing the clip handles, move the track to a different position, and fasten the clips to the lateral edges of the automobile hood. This is a very simple and convenient process to use and move the power track along the underside of an automobile hood. To fasten to the hood, the prior art utilized bendable ends, straps wrapped around the hood, or unstable magnets: all very cumbersome to use, as stated.

Another advantage of the present invention is its light weight. The track 55, comprising the channels 80 and 81, as stated, is very light weight, because it can be made of light weight material such as aluminum or thermoplastic. Stainless-steel corrugated gas piping is ideal for the tubing 51, because it is durable, and is designed to maintain its shape when bent; and therefore will not unfurl under the weight of the fixture head 53; and such piping is light weight. The invention will work even if the tube unfurls due to the weight of the pendent light. However, the invention works best when the tubing retains its configuration unless and until the user bends the tubing.

Miniature flashlight heads can and should be used as the fixture heads 53, which also are very light weight, and dissipate very little heat. Typical residential track light electrical bases can and should be used as the electrical base 54, which are light weight and very easy to install. If the aforementioned preferred elements are used, the entire present invention weighs very little. And because it contains the clips 60 and battery cable clamps 58, the present invention can be stored anywhere in the garage by clamping one of the clips 60 or battery cable clamps to a protrusion.

To connect the electrical base 54 to the lower channel 81, the electrical base 54 is simply inserted into the lower channel 81 and the electrical base 54 is turned in one direction, usually to the right. The electrical base 54 is equipped with electrical contact tabs (not shown) and snug fits into the lower channel 81. When the electrical base is turned to the right, the tabs contact the bus bars and the electrical base locks into place, the normal way a track light electrical base fastens to a track light.

The present invention is very easy to use, as stated, and economical to make. Power tracks are widely used as tracks for residential track lighting. An off-the-shelf track does not usually contain an upper channel 80. However, coupled with the above description and appended drawings, one skilled in the art could adapt an off-the-shelf track to receive the slidable clips 60. The same is true as to the other components of the present invention. If given the desired use of the tubing, the average corrugated tube manufacturer is skilled enough to make extensions with the semi-rigid properties described herein.

In stead of using battery cables 56, a miniature transformer can be used. Such transformers are typically used for residential track lighting, and are sized to attach to one of the ends of a typical residential-track-lighting track. These transformers usually are directly connected to electrical wiring connected to a power source. However, it is well known how to make miniature transformers that either connect to electrical wiring connected to an electrical plug, or that are rechargeable by an electrical power pack, or simply powered by a series of dry cell batteries connected to the transformer. In the latter case, a compartment could be added to one or both of the elongate tracks 55 to hold the batteries. These preferred embodiments are very advantageous. The battery powered embodiments could be used where electrical power sources are unavailable, such as on the highway at night when a motorist breaks down.

Still referring to FIGS. 1, 2A and B, a preferred embodiment comprises a line voltage pendant light fixture, comprising: a semi-rigid, repositionable corrugated tube 51; a light fixture head 53 with a lamp fixed at one tube end 52; an electrical base 54 fixed to the other tube end; electrical wiring inside the tube 51 extending the length of the tube 51 connected to the electrical base 54 and light fixture head 53; the electrical base 54 being detachably insertable inside the typical channel of a track-lighting track 55, being capable of making electrical contact with the bus bars 84 typically lining said channel; the tube 51 being repositionable so as a user could reposition the pendant light fixture by b ending the tube 51; wherein once bent into a position, the tube 51 remains rigid unless and until the user repositions the tube 51. This preferred embodiment has the advantage of being used for general purpose track lighting. It can be used in conjunction with typical track lighting in ceilings, or it can be mounted to a wall or furniture.

It will be evident, therefore, that a very simple and inexpensive construction of the adjustable underhood light in accordance with the present invention satisfies all of the objects cited above and overcomes all of the disadvantages inherent in prior art utility lights. While this invention has been described in detail with particular reference to preferred embodiments thereof, it will be understood that variations and modifications will be effected within the spirit and scope of the invention as described herein and as defined in the appended claims.

What is claimed is:

1. An adjustable light for suspension from an object having a nominal width and lateral edges, comprising: an elongated rigid frame, having a track axial axis, having opposing track ends along the axial axis, having two clips each being connected proximal to a separate opposing track end, and opposing upper and lower surfaces, said opposing track ends being clamped to the underside of a typical automobile hood by the clips when the hood is raised in a fixed position, and the frame being electrically connected to a power source;
and a plurality of pendant light fixtures, comprising a light fixture head; and a semi-rigid elongated extension; the extension being detachably and electrically connected to the frame lower surface and to the light fixture head; the extension being repositionable so as an auto mechanic working under said hood could reposition each pendant light fixture by bending the extension to variously illuminate remote and recessed engine components; wherein once bent into a position, the extension remains rigid unless and until the user repositions the extension.

2. An adjustable light, comprising: an elongated power track, having a track axial axis, having opposing track ends along the axial axis, having two clips each being connected proximal to a separate opposing track end, and opposing upper and lower surfaces, said opposing track ends being clamped to the underside of a typical automobile hood by the clips when the hood is raised in a fixed position, and the power track being electrically connected to a power source;
and a plurality of pendant light fixtures, comprising a light fixture head; and a semi-rigid elongated extension; the extension being detachably and electrically connected to the power track lower surface and to the light fixture head; the extension being repositionable so as an auto mechanic working under said hood could reposition each pendant light fixture by bending the extension to variously illuminate remote and recessed engine components; wherein once bent into a position, the extension remains rigid unless and until the user repositions the extension.

3. The adjustable light in clam 2, wherein the extension is made of corrugated tubing.

4. The adjustable light in claim 3, wherein the corrugated tubing is made of stainless steel, semi-rigid, low-pressure gas piping.

5. The adjustable light in claim 2, wherein the track being slightly arcuate, bowed toward the hood underside.

6. The adjustable light in claim 2, wherein the track being made of metal.

7. The adjustable light in claim 6, wherein the metal is aluminum.

8. the adjustable light in claim 2, wherein the track being made of thermoplastic.

9. The adjustable light in claim 2, wherein the track comprises upper channels along the track axial axis at each track end; wherein the clips contain planar portions being slidably inserted into separate upper channels along the track axial axis, wherein the overall length of the track being extendable by pulling the clips away from each other, sliding the planar portions partially beyond the track ends, whereby the clips can clamp to the lateral edges of the underside of an automobile hood of various sizes.

10. The adjustable light in claim 9, including a transformer at one track end and a power cord connecting the transformer to an electrical receptacle.

11. The adjustable light in claim 9, including a power source pack connected to one track end, comprising a transformer connected to a rechargeable battery.

12. The adjustable light in claim 9, including a power source pack connected to one track end, including a plurality of dry cell batteries inserted into slots in the lower track surface connected in series to the power source pack.

13. The adjustable light in claim 9, including battery cables having battery clamps, wherein the cables being electrically connected to one of the track ends.

14. An adjustable light, comprising: an elongated rigid frame, having opposing ends, having upper and lower opposing internal channels, sharing the same channel base, extending the length of the frame, defining the frame axial axis, and having bus bars inserted into the lower channel, extending the length of the lower channel;
two detachable clips each comprising planar portions sized to snug fit inside the upper channel, each clip planar portion being slidably inserted along the frame axial axis into the upper channel proximal to a separate opposing frame end; each clip planar portion being capable of sliding beyond the frame length and sliding back without detaching each clip, effectively extending the frame length, whereby the frame length is retractable; the frame length being sized so as each clip is capable of being attached to the lateral edges of a raised automobile hood;
battery cables, comprising electrical wiring and two clamps, one end of the electrical wiring being electrically connected to the clamps, the other end being electrically connected to the bus bars at one of the frame ends; the length of the being sized so as the clamps can be fastened to the leads of an automobile's battery while the hood is up and the clips are fastened to said lateral hood edges;
and a plurality of pendant light fixtures, comprising a light fixture head; a semi-rigid elongated extension, electrical wiring inserted inside the extension; and an electrical base connected to one extension end and the electrical wiring; the light fixture head being connected to the other extension end and electrical wiring; the electrical base being detachably connected to the lower channel and electrically connected to the bus bars; the extension being repositionable so as an auto mechanic working under said hood could reposition each pendant light fixture by bending the extension to variously illuminate remote and recessed engine components; wherein once bent into a position, the extension remains rigid unless and until the user repositions the extension.

15. An adjustable light, comprising: an elongated rigid frame, having opposing ends, having upper and lower opposing internal channels, sharing the same channel base, extending the length of the frame, defining the frame axial axis, and having bus bars inserted into the lower channel, extending the length of the lower channel;
two detachable clips each comprising planar portions sized to snug fit inside the upper channel, each clip planar portion being slidably inserted along the frame axial axis into the upper channel proximal to a separate opposing frame end; each clip planar portion being capable of sliding beyond the frame length and sliding back without detaching each clip, effectively extending the frame length, whereby the frame length is retractable; the frame length being sized so as each clip is capable of being attached to the lateral edges of a raised automobile hood;
and a plurality of pendant light fixtures, comprising a light fixture head; a semi-rigid elongated extension, electrical wiring inserted inside the extension; and an electrical base connected to one extension end and the electrical wiring; the light fixture head being connected to the other extension end and electrical wiring; the electrical base being detachably connected to the lower channel and electrically connected to the bus bars; the extension being repositionable so as an auto mechanic working under said hood could reposition each pendant light fixture by bending the extension to variously illuminate remote and recessed engine components; wherein once bent into a position, the extension remains rigid unless and until the user repositions the extension.

16. The adjustable light in claim 15, including battery cables, comprising electrical wiring and two clamps, one end of the electrical wiring being electrically connected to the clamps, the other end being electrically connected to the bus bars at one of the frame ends; the length of the being sized so as the clamps can be fastened to the leads of an automobile's battery while the hood is up and the clips are fastened to said lateral hood edges;
and including a pendent light fixture, comprising a light fixture head and an electrical base detachably connected to the lower channel and electrically connected to the bus bars.

17. The adjustable light in claim 15, including a transformer at one track end and a power cord connecting the transformer to an electrical receptacle.

18. The adjustable light in claim 15, including a power source pack connected to one track end, comprising a transformer connected to a rechargeable battery.

19. The adjustable light in claim 15, including a power source pack connected to one track end, including a plurality of dry cell batteries inserted into slots in the lower track surface connected in series to the power source pack.

20. A line voltage pendant light fixture, comprising: a semi-rigid, repositionable corrugated tube; a light fixture head with a lamp fixed at one tube end; an electrical base fixed to the other tube end; electrical wiring inside the tube extending the length of the tube connected to the electrical base and light fixture head; the electrical base being detachably insertable inside the typical channel of a track-lighting track, being capable of making electrical contact with the bus bars typically lining said channel; the tube being repositionable so as a user could reposition the pendant light fixture by bending the tube; wherein once bent into a position, the tube remains rigid unless and until the user repositions the tube.

21. An adjustable underhood light, comprising: an elongated power track, having opposing ends, having upper and lower opposing internal channels, sharing the same channel base, extending the length of the track, defining the track axial axis;
electrically conductive bus bars extending the length of the track, being inserted into the lower channel;
two detachable clips each comprising planar portions sized to snug fit inside the upper channel, each planar portion being slidably inserted along the track axial axis into the upper channel proximal to separate said track ends, wherein each planar clip portion is capable of partially sliding beyond the length of the track effectively extending the length of the track; the length of the track being sized so as each clip is capable of being fastened to the opposing lateral edges of the underside of a typical automobile hood when the hood is raised in a fixed position;
battery cables with two clamps, wherein the cables being connected to the bus bars at one of said track ends, the length of the cables being sized such that the clamps can be fastened to the leads of an automobile's battery while the hood is up and the clips are fastened to said lateral edges;
and a plurality of line voltage pendant light fixtures, comprising a repositionable, semi-rigid corrugated tube; a fixture head with a lamp, fixed at one tube end; an electrical base at the other tube end; electrical wiring inside the tube extending the length of the tube connected to the electrical base and fixture head; the electrical base being inserted inside the lower channel electrically contacting the electrically conductive bus bars; whereby power being transferred from the car battery to the fixture head lighting the lamp; the corrugated tubing being repositionable so as a mechanic working under the hood could reposition each pendant light fixture by bending the tube to variously illuminate remote and recessed engine components; wherein once bent into a position, the tube remains rigid unless and until the user repositions the tube.
